(19) United States
(12) Patent Application Publication
(10) Pub. No.: US 2026/0168477 A1
(43) Pub. Date: Jun. 18, 2026

(54) VEHICLE WIND POWER GENERATION SYSTEM

(71) Applicants: HYUNDAI MOTOR COMPANY, Seoul (KR); KIA CORPORATION, Seoul (KR); SHB AUTOMOTIVE MODULE CO., LTD., Gyeongsan-si (KR)

(72) Inventors: Jin Young Yoon, Hwaseong-si (KR); Hong Heui Lee, Hwaseong-si (KR); Dong Ha Kim, Hwaseong-si (KR); Bo Hwan Cha, Gyeongsan-si (KR); Je Yeop Lim, Gyeongsan-si (KR)

(73) Assignees: HYUNDAI MOTOR COMPANY, Seoul (KR); KIA CORPORATION, Seoul (KR); SHB AUTOMOTIVE MODULE CO., LTD., Gyeongsan-si (KR)

(21) Appl. No.: 19/317,861

(22) Filed: Sep. 3, 2025

(30) Foreign Application Priority Data
Dec. 17, 2024 (KR) 10-2024-0188086

(51) Int. Cl. F03D 9/32; B60R 16/023; B60R 19/52; H02K 7/18; H02N 11/00

(52) U.S. Cl. CPC F03D 9/32; B60R 16/0231; B60R 19/52; H02K 7/183; F05B 2240/941; H02N 11/008

(57) ABSTRACT

A vehicle energy harvesting system includes a grille positioned at a front surface of a vehicle body frame, at least one shutter unit positioned inside the grille and configured to open and close a portion of the grille, a power generator unit positioned adjacent to the shutter unit and fixed to the vehicle body frame, and a controller configured to control the shutter unit based on a vehicle speed.

### CROSS-REFERENCE TO RELATED APPLICATION

This application claims, under 35 U.S.C. § 119(a), the benefit of and priority to Korean Patent Application No. 10-2024-0188086, filed on Dec. 17, 2024, the entire contents of which are incorporated herein by reference.

### TECHNICAL FIELD

The present disclosure relates to an outside air flow control system for improving a vehicle's energy efficiency and aerodynamic performance. The present disclosure provides a system configured to open or close a front grille of a vehicle so that a wind power generation unit (e.g., blade, turbine) is operated or driven by utilizing wind energy or relative motion of air outside the vehicle relative to the vehicle during travelling when the front grille is open or aerodynamic resistance is minimized when the front grille is closed, improving fuel efficiency.

### BACKGROUND

The present disclosure relates to a vehicle wind power generation system. The vehicle wind power generation system uses a technology that utilizes natural wind energy, for example, energy from the relative motion or the movement of air outside the vehicle relative to the vehicle induced by driving of the vehicle during travelling to generate energy, improving energy efficiency of the vehicle. Particularly, the vehicle wind power generation system includes a system configured to, through a wind power generation unit mounted in a front grille of the vehicle and a shutter unit configured to control the wind power generation unit, generate power using wind energy or movement of air relative to the vehicle when the vehicle is at a low speed and reduce aerodynamic resistance by closing the front grille when the vehicle is at a high speed, improving fuel efficiency.

In the related art, airflow control technology has been mainly used to improve vehicle's fuel efficiency, and a method of optimizing aerodynamic performance by opening or closing the front grille of the vehicle is widely used. For example, for cooling an engine, the grille is opened when the vehicle is at a low speed, and for reducing air resistance, the grille is closed when the vehicle is at a high speed. The technology has an advantage of improving fuel efficiency by reducing aerodynamic resistance.

However, in the related art, there is a limit in generating wind power by utilizing energy resources because airflow is controlled only by opening or closing the front grille of the vehicle. Moreover, there is a problem that natural wind resources cannot be effectively utilized during travelling of the vehicle, and that the fuel efficiency can only be improved under certain circumstances. For this reason, there has arisen the need for technology to generate power by efficiently utilizing natural wind energy based on travel speed and to improve aerodynamic performance, at the same time.

To solve these problems, a power generation technology that utilizes a natural wind energy during travelling of a vehicle is currently and has recently been studied.

The above information disclosed in this Background section is provided only to enhance understanding of the background of the present disclosure. Therefore, the Background section may contain information that does not form the related art that is already known to one having ordinary skill in the art.

### SUMMARY

The present disclosure has been made in an effort to solve the above-described problems associated with the related art, and various aspects of the present disclosure are directed to providing a wind or air flow power generation system that utilizes natural wind energy (e.g., movement of air relative to a vehicle) during travelling of a vehicle to effectively generate energy, improving the energy efficiency of the vehicle. Moreover, the present disclosure is directed to providing the wind power generation system that controls the opening and closing of a front grille or a portion of the front grille of the vehicle based on the travel speed, enabling power generation when the vehicle is at a low speed and reducing air resistance when the vehicle is at a high speed to optimize aerodynamic performance to thereby improve the energy efficiency of the vehicle.

The aspects of the present disclosure are not limited to the foregoing, and other aspects of the present disclosure not mentioned herein may be understood based on the following description, and may be understood more clearly through the embodiments of the present disclosure. In addition, the aspects of the present disclosure may be realized by means and combinations thereof indicated in the claims.

A vehicle energy harvesting system to achieve the aspects of the present disclosure includes following configurations.

The present disclosure provides a vehicle energy harvesting system. The vehicle energy harvesting system includes a grille positioned at a front surface of a vehicle body frame, at least one shutter unit positioned inside the grille and configured to open and close a portion of the grille, a power generator unit positioned adjacent to the shutter unit and fixed to the vehicle body frame, and a controller configured to control the shutter unit based on a vehicle speed.

Moreover, in a hysteresis range where the absolute value of the difference between an increase in fuel efficiency due to power generated by energy harvesting and a decrease in fuel efficiency due to increased air resistance on the vehicle as the vehicle travels is equal to or less than a set value, the controller may control the shutter unit to keep the portion of the grille open if the portion of the grille is currently open or keep the portion of the grille closed if the portion of the grille is currently closed.

Moreover, the vehicle energy harvesting system may further include a bumper positioned at a front surface of the vehicle and along the grille. The shutter unit may include a shutter housing positioned adjacent to the grille and including a guide groove, a door configured to open and close the portion of the grille inserted into the guide groove, a link portion fastened to an inner surface of the door, an actuator fastened to the link portion, and a fixation panel positioned between the actuator and the bumper.

Moreover, the link portion may include a first link having a first end fastened to the actuator, a second link having a second end fastened to a second end of the first link, and a third link to which a second end of the second link is fastened. The third link may move in a vertical direction based the door moving in the height direction.

Moreover, the power generator unit may include a stator core, a core housing surrounding the stator core, a rotor inserted into inside the stator core, a first case facing a first end of the core housing, the rotor penetrating through the first case, a blade having a second end inserted into the first case, a second case surrounding a first end of the blade and brought into contact with a first end of the first case, and a cover fastened to one end of the second case. The power generator unit may be fixed to the vehicle body frame by a bracket unit.

Moreover, the first case and the second case each may have an open portion. The power generator unit may further include a front case fastened to the first case and the second case. The front case may have a first side facing the first case and the second case and a second side facing the blade.

Moreover, the bracket unit may include an extended plate fastened to the core housing, a connection bracket positioned below the power generator unit and fastened to the vehicle body frame, and a sub-bracket positioned below the cover and fastened to the vehicle body frame.

Moreover, the extended plate may have a first end fixed to the vehicle body frame and a second end fastened to the connection bracket, and the cover may be fastened to the sub-bracket.

The present disclosure provides a vehicle energy harvesting system, the system comprising: a grille disposed at a front of a vehicle body; a shutter unit disposed inside the grille configured to open and close a portion of the grille; a power generator unit positioned adjacent to the shutter unit; and a controller configured to control the shutter unit to open or closed the portion of the grille based on a vehicle speed.

A bumper may be positioned at a front of the vehicle along the grille, and the shutter unit may be coupled to a bottom portion of the bumper.

The shutter unit may include: a shutter housing adjacent to the grille including a guide groove; and a door disposed in the guide groove and configured to open or close the portion of the grille by traveling along the guide groove.

The system may further include: a link portion fastened to an inner surface of the door; and an actuator coupled to the link portion, the actuator configured to move the door so as to open or close the portion of the grille.

The system may further include: an actuator; a first link having a first end coupled to the actuator; a second link having a first end coupled to a second end of the first link; and a third link to which a second end of the second link is coupled. The actuator may be configured to move the door so as to open or close the portion of the grille.

The power generation unit may comprise: a blade; a stator core; a core housing surrounding the stator core; and a rotor disposed inside the stator core.

The controller may control the shutter unit to open the portion of the grille based on the vehicle speed decreasing below a first set value.

The controller may control the shutter unit to close the portion of the grille based on the vehicle speed increasing to exceed a second set value.

The present disclosure provides a vehicle energy harvesting system including: a grille disposed at a front of a vehicle body; a shutter unit including a shutter housing including a guide groove and a door disposed along the guide groove, the shutter unit disposed inside the grille and configured to open and close a portion of the grille; a power generator unit including a blade, a stator core, and a rotor disposed adjacent to the shutter unit; and a controller configured to control the shutter unit to move the door, opening or closing the portion of the grille based on a vehicle speed.

Moreover, the hysteresis range may be a range of a value greater than or equal to a first set value and smaller than a second set value.

Moreover, based on the vehicle speed increasing to exceed the second set value, the controller may control the shutter unit to close the portion of the grille.

Moreover, based on the vehicle speed decreasing to fall below the first set value, the controller may control the shutter unit to open the portion of the grille.

Other aspects and various embodiments of the present disclosure are discussed below.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are described in detail with reference to certain embodiments thereof illustrated in the accompanying drawings, which are given herein below by way of illustration only, and thus are not limitative of the present disclosure, and wherein:

FIG. 1 illustrates a vehicle equipped with an energy harvesting system, according to an embodiment of the present disclosure;

FIG. 2 illustrates a schematic diagram of a vehicle wind power generation system, according to an embodiment of the present disclosure;

FIGS. 3A and 3B illustrate an operation state of a shutter unit when a grille is open, according to an embodiment of the present disclosure;

FIGS. 3C and 3D illustrate an operation state of a shutter unit when a grille is closed, according to an embodiment of the present disclosure;

FIGS. 4A-4C illustrate a perspective view of a power generator unit, an exploded view of the power generator unit, and the power generator unit being attached to a vehicle, respectively, according to an embodiment of the present disclosure; and

FIG. 5 shows a hysteresis range, according to an embodiment of the present disclosure.

It should be understood that the appended drawings are not necessarily to scale, and present a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the same reference numerals refer to the same or equivalent parts of the present disclosure throughout the several figures of the drawing.

### DETAILED DESCRIPTION

Hereinafter, various embodiments of the present disclosure are described in detail with reference to the accompanying drawings. The embodiments of the present disclosure may be modified into various forms, and thus, the scope of the present disclosure should not be construed as being limited to the following embodiments. The embodiments are provided to more completely explain the present disclosure to those of ordinary skill in the art.

Furthermore, terms such as “. . . portion,” “. . . unit,” etc. used in the present specification each refer to a unit that processes at least one function or operation, and may be implemented as hardware, software or a combination thereof.

The terminology used herein is for describing various embodiments only, and is not intended to be limiting. A singular representation may include a plural representation unless it represents a definitely different meaning from the context.

The terms “comprises” and/or “comprising” used in this specification mean that the cited component does not exclude the presence or addition of one or more of other components but may further comprise other components unless otherwise specified. Moreover, terms such as “. . . portion,” “. . . unit,” etc. used in this specification refer to a unit that processes at least two functions or operations.

A controller 500 may be implemented as a memory that stores algorithms for controlling operation of various components placed in a vehicle or data on a program that reproduces algorithms and a processor that performs the above described operation using data stored in the memory. In one example, the memory and the processor may be implemented as separate chips. Alternatively, the memory and the processor may be implemented as a single chip. For example, the controller 500 may include at least two selected from an electronic control unit (ECU), a central processing unit (CPU), a microprocessor unit (MPU), a micro controller unit (MCU), an application processor (AP) or any form of processor well known in the art to which the present disclosure pertains.

In addition, the controller 500 may be a combination of software and hardware capable of performing calculations for at least two applications or programs to execute a method according to the embodiments of the present disclosure. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

Moreover, in this specification, “fuel efficiency” includes the fuel efficiency of internal combustion engine vehicles, the power efficiency (power consumption efficiency) of electric vehicles, and the fuel efficiency and power efficiency of hybrid vehicles. Therefore, the term fuel efficiency refers to the consumption efficiency of the corresponding fuel or power source for each type of vehicle, and the technical effects of the present disclosure are applicable to all of internal combustion engine vehicles, electric vehicles, and hybrid vehicles.

In internal combustion engine vehicles, “fuel efficiency” refers to the amount of fuel consumed by the vehicle to travel a specific distance, and is generally used as an indicator of the efficiency of fuel consumption. Fuel efficiency is generally expressed in L/km (liter per kilometer) or mpg (miles per gallon), and is determined based on fuel consumption and travel distance.

In electric vehicles, “power efficiency” refers to the amount of power consumed to travel a specific distance, and is a concept closely related to the battery state of charge (SOC). Power efficiency is generally expressed in km/kWh (kilometer per kilowatt hours) and indicates the efficiency of travel distance relative to battery consumption.

In hybrid vehicles, both fuel efficiency and power efficiency are considered important, and are used as indicators for comprehensively evaluating the energy consumption efficiency of internal combustion engines and electric motors. In hybrid vehicles, fuel consumption of internal combustion engines and battery power consumption are both considered to determine comprehensive energy efficiency.

Furthermore, in this specification, a height direction is the vertical direction, for example, extending from the vehicle body floor to the vehicle body ceiling.

Hereinafter, embodiments are described in detail with reference to the accompanying drawings, and in the description provided with reference to the accompanying drawings, the same or corresponding components are assigned the same reference numerals, and a duplicative or redundant description thereof is not provided.

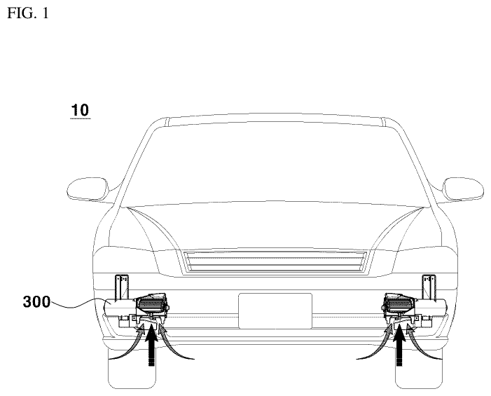

FIG. 1 illustrates a vehicle equipped with an energy harvesting system.

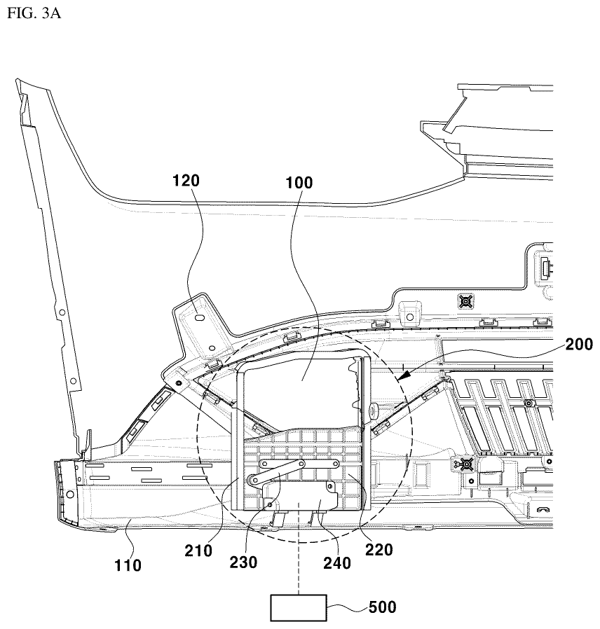

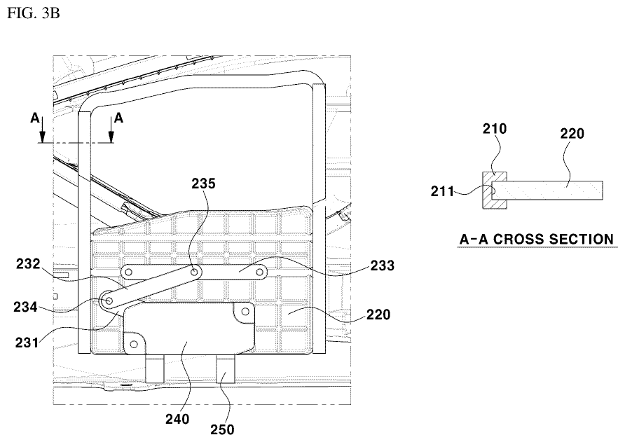

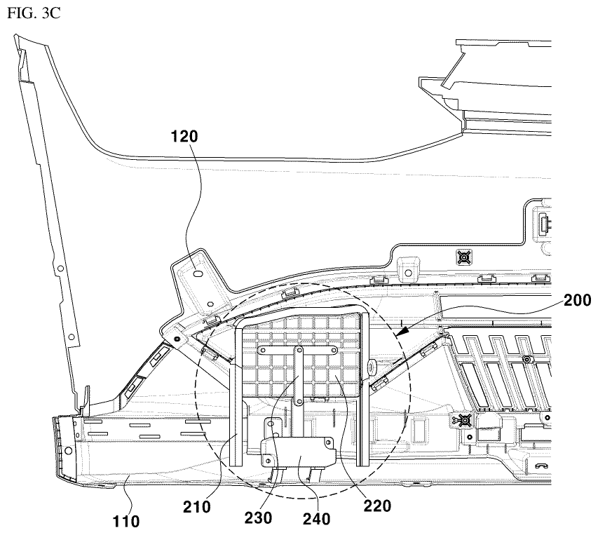

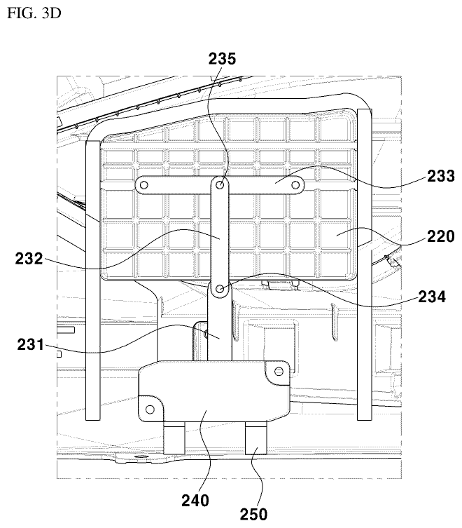

According to an embodiment of the present disclosure, a vehicle energy harvesting system 10 includes at least one shutter unit 200 (see FIG. 3A) configured to open and close a grille 100 positioned at a front surface of a vehicle body frame 120. For example, the at least one shutter unit 200 may be configured to open and close a portion of the grille 100. The vehicle energy harvesting system 10 includes a power generator unit 300 positioned adjacent to the shutter unit 200 and fixed to the vehicle body frame 120, and a controller 500 configured to control the shutter unit 200 based on a vehicle speed.

The grille 100 positioned at the front surface of the vehicle body frame 120 has a shape in which the internal portion of the grille 100 is open. Furthermore, the grille 100 has a shape in which at least a portion of the grille 100 is surrounded by a bumper 110 positioned at the front surface of the vehicle. The grille 100 may have a vertical, horizontal, hexagonal, and/or polygonal grid shape, and may be designed in various sizes and patterns to optimize the design and air flow of the vehicle.

The shutter unit 200 configured to open and close the grille 100 (e.g., a portion of the grille 100) is positioned at an internal side of the grille 100. In one example, at least one shutter unit 200 may be positioned at each of opposite internal sides or side surfaces of the grille 100.

The shutter unit 200 is configured to open and close the grille 100 (e.g., a portion of the grille 100). The shutter unit 200 includes a shutter housing 210 positioned adjacent to the grille 100, a door 220 positioned inside the shutter housing 210, a link portion 230 fastened to an inner surface of the door 220, and an actuator 240 fastened to the link portion 230. In one or some embodiments, the shutter unit 200 may be configured to open and close a portion of the grille 100 corresponding to an interior or a portion of an interior of the shutter housing 210.

The shutter housing 210 is positioned at a rear end or side of the grille 100. Furthermore, the shutter housing 210 may be positioned to face the vehicle body frame 120. A lower end of the shutter housing 210 may be fastened to a lower end of the bumper 110 positioned at the front surface of the vehicle.

Moreover, the shutter housing 210 has an internal structure which allows the door 220 having a shape identical to or similar to the grille 100 or a portion of the grille 100 to smoothly move upward and downward in the height or vertical direction. For example, when the grille 100 or a portion of the grille 100 configured to be opened or closed by the shutter unit 200 has a hexagonal or polygonal shape, the internal portion of the shutter housing 210 may include a guide groove 211 corresponding to the shape of the grille 100 or portion of the grille 100 be opened or closed which allows the door 220 to move (see FIG. 3B). Accordingly, the door 220 may move upward and downward in a manner corresponding to the shape of the grille 100 within the shutter housing 210. The shutter housing 210 may serve to stably or reliably guide the movement of the door 220.

The door 220 mounted in the guide groove 211 in the shutter housing 210 moves in a direction which opens or closes the grille 100 (e.g., a portion of the grille 100) along the guide groove 211. Moreover, the door 220 may move upward and downward in the height or vertical direction by being fastened to the link portion 230. Furthermore, the grille 100 (e.g., a portion of the grille 100) may be closed when the door 220 moves upward in the height or vertical direction, and may be open when the door 220 moves downward in the height or vertical direction.

At least a portion of the link portion 230 configured to move the door 220 upward and downward in the height direction is fastened to the inner surface of the door 220. Moreover, at least a portion of the link portion 230 is connected to a rotational or rotating shaft of the actuator 240.

Furthermore, the link portion 230 includes a first link 231 having one (e.g., a first) end fastened to the actuator 240, a second link 232 having one (e.g., a first) end fastened to another (e.g., second) end of the first link 231, and a third link 233 configured to move in the height direction by being fastened to another (e.g., second) end of the second link 232.

The one (e.g., first) end of the first link 231 is fastened to the rotational or rotating shaft of the actuator 240. The one (e.g., first) end of the second link 232 may be connected to the other (e.g., second) end of the first link 231 through a first connecting portion 234 in a state of having a rotational degree of freedom (e.g., so as to be free to rotate relative to the first link 231). In this example, the first connecting portion 234 may have a pin shape inserted into the other (e.g., second) end of the first link 231, or may have a shape in which the first connecting portion 234 is extended from the other (e.g., second) end of the first link 231 to protrude in a direction perpendicular to the surface of the other (e.g., second) end of the first link 231.

The second link 232 rotates together with the first link 231 when the first link 231 rotates through or via the first connecting portion 234. Furthermore, the other (e.g., second) end of the second link 232 may be fastened to the center of the third link 233. In this example, the other (e.g., second) end of the second link 232 may be fastened to a second connecting portion 235 positioned at the center of the third link 233. The second connecting portion 235 may have a shape in which the second connecting portion 235 extends to protrude in a direction perpendicular to the surface of third link 233.

The third link 233 is configured to move the door 220 upward and downward in the height or vertical direction of the vehicle by being horizontally fastened to the inner surface of the door 220. In this example, the third link 233 moves integrally with the door 220 in the height direction of the vehicle.

In other words, the third link 233 moves upward or downward in the height direction of the vehicle through or via the rotation of the first link 231 and the second link 232, and the door 220 fastened to the third link 233 moves upward or downward in the height direction of the vehicle along the guide groove 211 in the shutter housing 210 to thereby open or close the grille 100.

When the grille 100 or a portion of the grille 100 is open by the up-down movement of the door 220, air outside of the vehicle is introduced into the vehicle body floor through the grille 100 or the portion of the grille 100. When the outside air is introduced into the vehicle body floor, the power generator unit 300 positioned at a rear end of the shutter unit 200 performs energy harvesting (e.g., generates power) using motion of the outside air relative to the vehicle 10.

The power generator unit 300 is positioned at the rear end of (e.g., behind) the shutter unit 200 and is fastened to the vehicle body frame 120 through a bracket unit 400. The power generator unit 300 is operated by wind energy (e.g., energy of air moving relative to the vehicle during driving or traveling of the vehicle) and is operated depending on whether the grille 100 (e.g., portion of the grille 100) is open or closed.

Specifically, when outside air is introduced into the front surface portion of the vehicle through the grille 100, the outside air passes through the shutter unit 200 and reaches the power generator unit 300. A rotatable blade 350 is mounted inside the power generator unit 300, and the outside air introduced into the front portion of the vehicle rotates the blade 350. The blade 350 is rotated by wind energy, and the rotational motion of the blade 350 is transmitted to a rotor 330 connected to the blade 350.

The rotor 330 rotates to generate electromagnetic induction within a stator core 310, and electricity is generated by the electromagnetic induction. In this way, the wind energy or energy of the outside air introduced into the vehicle rotates the blade 350 in the power generator unit 300 to generate electricity. The generated power may be stored in an auxiliary battery 50 or main battery 60 within the vehicle and used as an energy source for the vehicle.

Whether to operate the power generator unit 300 is determined depending on whether the grille 100 (e.g., portion of the grille 100) is open or closed. The controller 500, configured to control whether to open or close the grille 100 (e.g., portion of the grille 100) by controlling the shutter unit 200, receives the vehicle speed from a speed sensor and controls the shutter unit 200 to open or close the grille 100 (e.g., portion of the grille 100) based on a set value set in the controller 500.

Moreover, the controller 500 controls the shutter unit 200 to keep the grille 100 (e.g., portion of the grille 100) open or closed when the vehicle is traveling within a set vehicle speed range. The set vehicle speed range may be a hysteresis range. In other words, the hysteresis range is a range in which the grille 100 (e.g., portion of the grille 100) is kept or maintained in an open or closed state, which is the state of the grille 100 (e.g., portion of the grille 100) prior to the vehicle speed entering the hysteresis range.

The hysteresis range is a range where the absolute value of the difference between the fuel efficiency increase due to the power generated by energy harvesting and the fuel efficiency decrease due to the increased air resistance of the travel wind is equal to or less than the set value.

The hysteresis range may be set based on the vehicle speed. The hysteresis range is a range of a value equal to or greater than a first set value and less than a second set value. In this example, the first set value is a vehicle speed which is less than the second set value.

The controller 500 operates the shutter unit 200 to close the grille 100 (e.g., portion of the grille 100) in response to the vehicle speed being increased to exceed the second set value. Conversely, the controller 500 operates the shutter unit 200 to open the grille 100 (e.g., portion of the grille 100) in response to the vehicle speed being decreased to fall below the first set value.

Specifically, when the current travel speed of the vehicle is less than the first set value, the controller 500 opens the grille 100 (e.g., portion of the grille 100). Even when the vehicle speed gradually increases and exceeds the first set value in the state of the grille 100 being open, the controller 500 operates the shutter unit 200 to keep the grille 100 open until the vehicle speed reaches the second set value.

Conversely, when the current travel speed of the vehicle is smaller than the second set value, the controller 500 closes the grille 100 (e.g., portion of the grille 100). Even when the vehicle speed gradually decreases and falls below the second set value, the controller 500 keeps the grille 100 closed until the vehicle speed reaches the first set value.

In the case of electric vehicles, when travelling at low speeds, the grille 100 may be used to perform energy harvesting through the power generator unit 300 to charge the battery and increase the battery state of charge (SOC).

When the vehicle's travel speed is greater than or equal to the first set value and smaller than the second set value, the speed enters the hysteresis range. In the hysteresis range, the absolute value of the difference between the fuel efficiency increase due to battery charging and the fuel efficiency decrease due to the increased air resistance caused by the travel wind when the grille 100 (e.g., portion of the grille 100) is open is equal to or smaller than the set value.

In the hysteresis range, the effect of fuel efficiency improvement due to the increase in battery charge applied through energy harvesting is substantially the same as the fuel efficiency reduction due to the increase in air resistance of the travel wind, so the state of the grille 100 (e.g., portion of the grille 100) prior to entering the hysteresis range is kept as it is.

In the case of an internal combustion engine vehicle, when the travel speed is equal to or smaller than the first set value, the controller 500 opens the grille 100 (e.g., portion of the grille 100) to secure the amount of the auxiliary battery charge through wind power generation, improving the engine cooling efficiency and the fuel efficiency, and additionally supplying the power required for the electrical components.

Conversely, when the travel speed exceeds the second set value, the controller 500 closes the grille 100 (e.g., portion of the grille 100) to reduce aerodynamic resistance, improving the fuel efficiency. The reduction in aerodynamic resistance by closing the grille 100 plays an important role in reducing fuel consumption during high-speed travelling and increasing the energy efficiency of the vehicle.

In the hysteresis range where the travel speed fluctuates between the first set value and the second set value, the increase in battery charge due to the opening of the grille 100 and the increase in engine cooling efficiency due to the increase in outside air flow and improvement in fuel efficiency resulting therefrom substantially correspond to the decrease in fuel efficiency due to the increase in air resistance.

Therefore, in the hysteresis range, the controller 500 keeps or maintains the grille 100 (e.g., portion of the grille 100) open or closed, consistent with the state of the grille 100 prior to entering the hysteresis range, preventing energy loss due to unnecessary switching of the state of the grille 100 being open or closed, and optimizing travel efficiency.

In a hybrid vehicle, when the travel speed is smaller than the first set value, the controller 500 opens the grille 100 (e.g., portion of the grille 100) to provide various benefits. Because an electric motor is mainly used during low-speed travelling, the grille 100 is opened to operate the energy harvesting system to generate power.

In a hybrid vehicle, the power generation amount increases due to the energy of the wind introduced by opening the grille 100, which increases the battery charge, and the battery charge state of the electric motor increases, which expands the electric driving range of the hybrid system, thereby improving fuel efficiency. Moreover, as outside air is introduced into the engine, the engine cooling efficiency increases, which increases the exhaust gas recirculation efficiency, improving fuel efficiency. Furthermore, because the generated power is directly supplied to the electrical components, the load of the generator that supplies power to the electrical components is reduced to thereby reduce fuel consumption, improving fuel efficiency.

Conversely, when the travel speed exceeds the second set value, the controller 500 closes the grille 100 (e.g., portion of the grille 100) to reduce aerodynamic resistance, improving fuel efficiency. Closing the grille 100 reduces aerodynamic resistance at the front of the vehicle, further improving fuel efficiency during high-speed travelling. The engine load is reduced due to the reduced aerodynamic resistance, improving energy efficiency during high-speed travelling.

In the hysteresis range, the travel speed fluctuates between the first set value and the second set value. Moreover, in the hysteresis range, the grille 100 (e.g., portion of the grille 100) is opened, resulting in increased battery charge due to energy harvesting, increased engine cooling efficiency due to outside air, and reduced generator load due to energy harvesting, thereby providing the effect of fuel efficiency improvement. Here, the effect of fuel efficiency improvement corresponds to the amount of fuel efficiency reduction due to increased aerodynamic resistance by the travel wind.

Therefore, in the hysteresis range, the controller 500 keeps the grille 100 (e.g., portion of the grille 100) open or closed, corresponding to the state of the grille 100 prior to entering the hysteresis range, preventing energy loss due to unnecessary switching of the state of the grille 100 being open or closed, and optimizing travel efficiency.

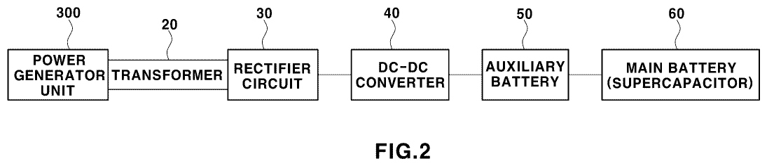

FIG. 2 illustrates a schematic diagram of a vehicle wind power generation system.

According to an embodiment of the present disclosure, the vehicle energy harvesting system first opens the grille 100 so that outside air is introduced into the front of the vehicle. The outside air introduced into the front of the vehicle reaches the power generator unit 300 and rotates the blade 350. As the blade 350 rotates, the power generator unit 300 operates, and energy harvesting is performed by the operation of the power generator unit 300 to generate power. The generated power is first transmitted to a transformer 20 through the power generator unit 300. The transformer 20 converts the voltage of the introduced power and adjusts the current to a level that may be appropriately used in the next stage.

The power converted in the transformer 20 is transmitted to a rectifier circuit 30, and the rectifier circuit 30 converts alternating current (AC) power into direct current (DC) power. In this example, the process of converting AC power into DC power is the rectification process. In the rectification process, the waveform of AC power is aligned to DC, ensuring electrical stability.

The current converted into DC power is transmitted to a DC-DC converter 40. The DC-DC converter 40 further adjusts the converted DC current to a voltage suitable for the auxiliary battery 50 and the main battery 60. Through the adjusting process, the current is adjusted to a state where the current can be stably transmitted to the auxiliary battery 50.

The adjusted current is stored in the battery portion of the vehicle. The battery portion of the vehicle includes at least one auxiliary battery 50 configured to support the electric vehicle's electrical components and the main battery 60 configured to supply power to a driving motor.

The adjusted current may be first sequentially charged to a plurality of auxiliary batteries 50. The auxiliary battery 50 may be electrically connected to the main battery 60, and the current applied from the power generator unit 300 may charge the auxiliary battery 50 in advance. The auxiliary battery 50 and the main battery 60 may be electrically connected in series or in parallel depending on the design.

The auxiliary battery 50 is configured to be charged with priority over (e.g., before) the main battery 60 by the power generator unit 300 so as to transmit current to the main battery 60 when the main battery 60 needs power. The auxiliary battery 50 serves to supply stable low-voltage power to the electrical components and to support the high-voltage supply of the main battery 60. This allows the auxiliary battery 50 to continuously supply low-voltage power required for the electrical components while the main battery 60 maintains a high voltage for driving the vehicle, helping the system of the electric vehicle to operate stably through balanced power management.

FIGS. 3A and 3B illustrate an operation state of the shutter unit 200 when the grille 100 (e.g., portion of the grille 100) is open. FIGS. 3C and 3D illustrate an operation state of the shutter unit 200 when the grille 100 (e.g., portion of the grille 100) is closed.

According to an embodiment of the present disclosure, the shutter unit 200 includes the shutter housing 210 positioned adjacent to the grille 100 and including the guide groove 211, the door 220 inserted into the guide groove 211 to open and close the grille 100 (e.g., portion of the grille 100), the link portion 230 fastened to the inner surface of the door 220, the actuator 240 configured to operate the link portion 230, and a fixation panel 250 positioned between the actuator 240 and the bumper 110 of the vehicle.

The shutter housing 210 is positioned on the inner side surface of the grille 100. Here, a portion of the shutter housing 210 makes surface-to-surface contact with the vehicle body frame 120 and surrounds the inner side surface of the grille 100. Furthermore, a lower end of the shutter housing 210 is fastened to a lower end of the bumper 110 positioned at the front surface of the vehicle.

Moreover, the guide groove 211 is formed inside the shutter housing 210, and the door 220 is designed to be able to move upward and downward in the height direction along the guide groove 211.

Moreover, the door 220 is connected to the actuator 240 through the link portion 230, and the door 220 moves upward and downward by driving of the actuator 240 to open and close the grille 100 (e.g., portion of the grille 100).

The link portion 230 configured to move the door 220 upward and downward in the height direction along the guide groove 211 includes the first link 231 having one (e.g., a first) end fastened to the actuator 240, the second link 232 having one (e.g., a first) end fastened to another (e.g., second) end of the first link 231, and the third link 233 horizontally fixed to the inner surface of the door 220 and having another (e.g., second) end of the second link 232 fastened to the third link 233.

The one (e.g., first) end of the first link 231 is fastened to the actuator 240. Here, for example, the one (e.g., first) end of the first link 231 is fastened to a drive shaft of the actuator 240. The first link 231 is fixed to the drive shaft of the actuator 240 and rotates integrally or together with the drive shaft. The first link 231 may rotate in the rotational direction of the drive shaft.

The second link 232 has one (e.g., a first) end connected to the other (e.g., second) end of the first link 231 through the first connecting portion 234, and has another (e.g., second) end connected to the center of the third link 233 through the second connecting portion 235. Therefore, when the first link 231 rotates about the drive shaft, the other (e.g., second) end of the second link 232 moves upward and downward in the height direction, and the one (e.g., first) end of the second link 232 rotates about the other (e.g., second) end of the second link 232.

Specifically, as illustrated in FIGS. 3A and 3B, when the drive shaft rotates, based on the drawing, clockwise, the first link 231 rotates clockwise about the drive shaft. At this time, an external force is applied to the one (e.g., first) end of the second link 232 through the first connecting portion 234. The external force moves the other (e.g., second) end of the second link 232 upward and downward in the height direction, and rotates the one (e.g., first) end of the second link 232 about the second connecting portion 235. At this time, the one (e.g., first) end of the second link 232 rotates counterclockwise.

Furthermore, the other (e.g., second) end of the second link 232 moves upward in the height direction, and the third link 233 connected to the other (e.g., second) end of the second link 232 moves upward in the same direction as the other (e.g., second) end of the second link 232. The door 220 connected to the third link 233 also moves upward in the same direction as the other (e.g., second) end of the second link 232. When the first link 231 rotates clockwise and the second link 232 rotates counterclockwise so that the first link 231 lines up with the second link 232, the door 220 moves upward in the height direction and is positioned at the maximum height inside the shutter housing 210. In this example, the upper end of the door 220 makes surface-to-surface contact with the lower surface of the upper end of the shutter housing 210. As a result, the grille 100 (e.g., portion of the grille 100) is closed. When the grille 100 (e.g., portion of the grille 100) is closed, outside air is not introduced into the inside of the vehicle body floor, and the power generator unit 300 stops operating.

Conversely, as illustrated in FIGS. 3C and 3D, when the grille 100 (e.g., portion of the grille 100) is switched from being closed to be opened, the actuator 240 operates the drive shaft in a direction opposite to the direction in which the drive shaft is operated when grille 100 is opened. For example, the drive shaft may rotate counterclockwise. When the drive shaft rotates counterclockwise, the first link 231 rotates counterclockwise about the drive shaft.

The other (e.g., second) end of the first link 231 pulls the one (e.g., first) end of the second link 232 in a direction adjacent to one (e.g., a first) side of the shutter housing 210. By the first link 231, the one (e.g., first) end of the second link 232 rotates in a direction adjacent to the one (e.g., first) side of the shutter housing 210 with respect to the second connecting portion 235. For example, the second link 232 may rotate clockwise. In this example, the other (e.g., second) end of the second link 232 is moved downward in the height direction, and the third link 233 is moved downward in the height direction together with the other (e.g., second) end of the second link 232. When the third link 233 is moved downward, the door 220 is moved downward in the height direction together with the third link 233.

When the door 220 is moved downward and the lower end of the door 220 comes into contact with the bumper 110, the height-direction downward movement of the door 220 stops. As a result, the grille 100 (e.g., portion of the grille 100) is opened, and outside air is introduced through the grille 100 to operate the power generator unit 300.

As a different embodiment of the present disclosure, the door 220 may be a flap-type door. When a flap-type door 220 is used, at least one or more linkages are arranged on internal opposite side surfaces of the shutter housing 210. The linkage may be positioned parallel to the height direction of the vehicle and may be coupled to the flap-type door 220 through a lever crank system or a cam mechanism.

The linkage rotates horizontally by the operation of the actuator 240, and the lever crank system or cam mechanism converts the horizontal rotational motion of the linkage into the upward and downward motion of the flap-type door 220.

Specifically, the linkage and the flap-type door 220 are connected to each other through the crank system or cam mechanism. By the crank system or cam mechanism, the flap-type door 220 is configured to rotate in the height direction about a rotational shaft inserted into the linkage to have a predetermined angle with respect to the height direction.

When the linkage is rotated by the operation of the actuator 240, the crank system or cam mechanism converts the rotational motion of the linkage into the upward and downward motion of the flap-type door 220, allowing the door 220 to move in a direction of opening or closing the grille 100 (e.g., portion of the grille 100).

The flap-type door 220 tilts in the direction of opening the grille 100 by the rotation of the linkage. For example, the flap-type door 220 may be rotated to move upward in the height or vertical direction with respect to the rotational shaft. When the flap-type door 220 is rotated to move upward in the height direction, a passage through which outside air may be introduced is formed.

Conversely, when the linkage rotates to rotate the flap-type door 220 to move downward in the height direction, the passage through which outside air may be introduced is blocked.

With this structure, the horizontal rotational motion of the linkage may be converted into the upward and downward motion of the flap-type door 220 in the height direction and changes the flap-type door 220 in angle, allowing the opening and closing state of the grille 100 to be effectively controlled.

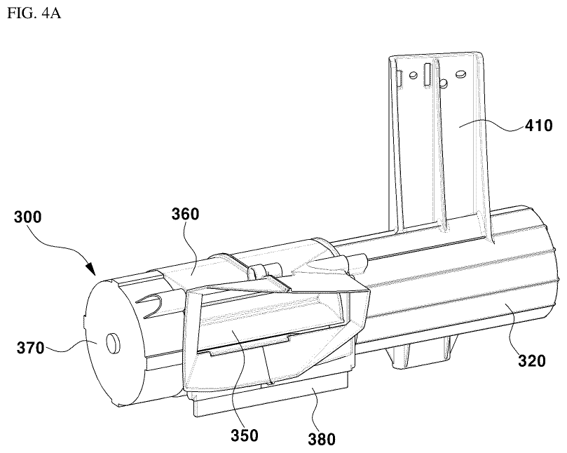

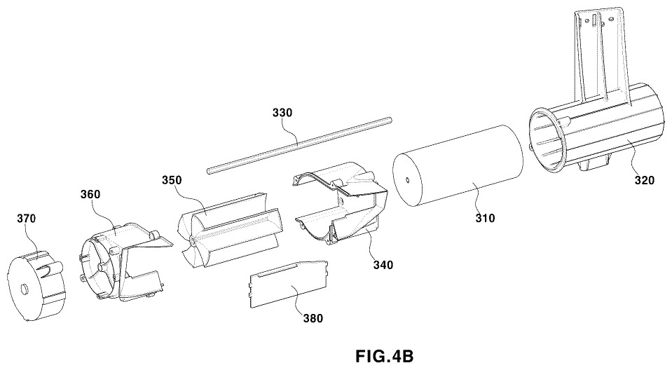

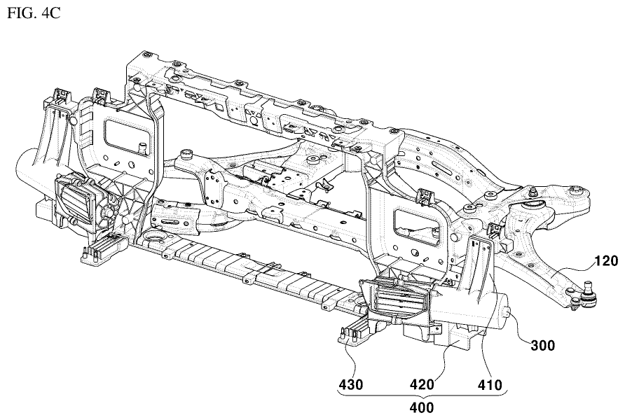

FIGS. 4A-4C illustrate a perspective view of the power generator unit 300, an exploded view of the power generator unit 300, and the power generator unit 300 being attached to a vehicle, respectively.

According to an embodiment of the present disclosure, the power generator unit 300 is positioned at a rear end of the shutter unit 200 and is fixed to the vehicle body frame 120 through the bracket unit 400.

Furthermore, the power generator unit 300 includes the stator core 310, a core housing 320 surrounding the stator core 310, the rotor 330 inserted into the inside of the stator core 310, a first case 340 through which the rotor 330 passes and facing one (e.g., a first) end of the core housing 320, the blade 350 having another (e.g., a second) end inserted into the first case 340, a second case 360 surrounding one (e.g., a first) end of the blade 350 and brought into contact with one (e.g., a first) end of the first case 340, and a cover 370 fastened to one (e.g. a first) end of the second case 360.

As illustrated in FIGS. 4A and 4B, the stator core 310 is positioned in the center of the power generator unit 300. Moreover, the stator core 310 is surrounded by the core housing 320.

The rotor 330 inserted into the inside of the stator core 310 rotates inside the stator core 310 to cause electromagnetic induction, generating power. Moreover, one (e.g., a first) end of the rotor 330 is inserted into the core housing 320, and another end of the rotor 330 penetrates the first case 340 and is inserted into the inside of the blade 350. Therefore, when the blade 350 is rotated by the outside air, the rotor 330 rotates in the same direction as the blade 350. At this time, the rotor 330 interacts with the stator core 310 to generate power through the electromagnetic induction.

The other end of the blade 350 that is rotated by the outside air introduced through the grille 100 is surrounded by the first case 340, and the one (e.g., first) end of the blade 350 is surrounded by the second case 360 facing the one (e.g., first) end of the first case 340.

Another end of the first case 340 is fastened to the core housing 320 by making surface-to-surface contact with the one (e.g., first) end of the core housing 320. Furthermore, the first case 340 has a shape in which at least a portion of the first case 340 is open. For example, upper and lower ends of the first case 340 may extend in the length direction of the blade 350, and opposite side ends of the first case 340 may be open.

The second case 360 brought into contact with the first case 340 has a shape in which at least a portion of the second case 360 is open, similar to the shape of the first case 340. For example, upper and lower ends of the second case 360 may extend in the length direction of the blade 350, and opposite side ends of the second case 360 may be open.

Accordingly, the upper end of the second case 360 comes into contact with the upper end of the first case 340, and the lower end of the second case 360 comes into contact with the lower end of the first case 340. In this structure, the upper and lower ends of the blade 350 are surrounded by the first case 340 and the second case 360.

The blade 350 rotates as the outside air is introduced into the open portions of the first case 340 and the second case 360. A front case 380 is fastened to the first case 340 and the second case 360 to prevent damage to the blade 350 due to foreign substances contained in the outside air (e.g., coming into contact with the blade 350) when the blade 350 is rotated by the outside air. For example, the front case 380 may be fastened to the first case 340 and the second case 360 so that one (e.g., a first) side of the front case 380 faces the first case 340 and the second case 360 and another (e.g., second) side of the front case 380 faces the blade 350.

Moreover, the front case 380 may disperse vibrations or shocks that may be generated during the rotation of the blade 350, providing structural stability of the power generator unit 300.

Furthermore, the power generator unit 300 is, as illustrated in FIG. 4C, fastened to the vehicle body frame 120 through the bracket unit 400 to minimize vibration and noise generated when the blade 350 rotates.

The bracket unit 400 may include an extended plate 410, a connection bracket 420, and a sub-bracket 430.

At least a portion of the extended plate 410 having a shape in which the height-direction length of the extended plate 410 is extended is fastened to an external side surface of the core housing 320. Moreover, one (e.g., a first) end of the extended plate 410 is fastened to the vehicle body frame 120, and another end of the extended plate 410 is fastened to the connection bracket 420 positioned below the power generator unit 300. Accordingly, the connection bracket 420 connects the extended plate 410 and the vehicle body frame 120 to each other to fix the power generator unit 300 to the vehicle body frame 120.

Moreover, the power generator unit 300 is fixed to the vehicle body frame 120 by the sub-bracket 430 that is fastened to the second case 360. The sub-bracket 430 is positioned below the cover 370 surrounding the one (e.g., first) end of the second case 360, and connects the second case 360 and the vehicle body frame 120 to each other to fasten the power generator unit 300 to the vehicle body frame 120.

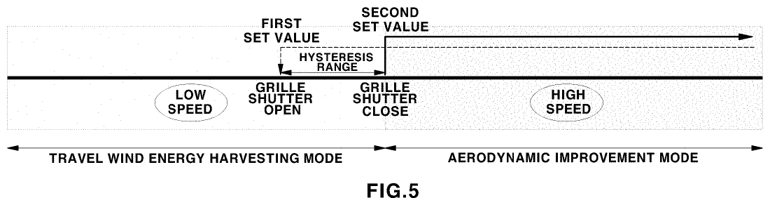

FIG. 5 shows a hysteresis range depending on a vehicle speed.

According to an embodiment of the present disclosure, the controller 500 receives the vehicle speed through a speed sensor and controls the opening and closing of the grille 100. The controller 500 controls the shutter unit 200 to open or close the grille 100 (e.g., portion of the grille 100) by setting a first set value, a second set value, and a hysteresis range based on the vehicle speed.

When the vehicle speed decreases to be equal to or smaller than the first set value, the controller 500 operates the shutter unit 200 to open the grille 100 (e.g., portion of the grille 100). When the grille 100 (e.g., portion of the grille 100) is opened and the air flowing in from the front of the vehicle reaches the blade 350 in the power generator unit 300, the power generator unit 300 is operated to perform energy harvesting.

Moreover, opening the grille 100 (e.g., portion of the grille 100) provides the effect of reducing the braking distance by increasing air resistance at braking during travelling of the vehicle. Even when not travelling, i.e., when the vehicle is parked or stopped, the shutter unit 200 is kept open to continuously generate electricity by rotating the blade 350 using natural wind.

When the vehicle speed exceeds the second set value, the controller 500 operates the shutter unit 200 to close the grille 100 (e.g., portion of the grille 100). When the grille 100 is closed, the aerodynamic resistance of the vehicle is reduced, improving fuel efficiency. Closing the grille 100 (e.g., portion of the grille 100) during high-speed travelling contributes to reducing air resistance, maximizing the fuel efficiency of the vehicle. Under this circumstance, the grille 100 (e.g., portion of the grille 100) is kept being closed by giving priority to aerodynamic improvement over energy harvesting.

When the vehicle speed enters the hysteresis range where the vehicle speed is greater than or equal to the first set value and smaller than the second set value, the controller 500 controls the shutter unit 200 to keep the state (e.g., opened, closed) of the grille 100 prior to entering the hysteresis range as it is.

For example, when the grille 100 (e.g., portion of the grille 100) is in the state of being open prior to entering the hysteresis range, the controller 500 controls the shutter unit 200 so that the grille 100 is kept being open in the hysteresis range. Conversely, when the grille 100 is in the state of being closed prior to entering the hysteresis range, the controller 500 controls the shutter unit 200 so that the grille 100 is kept being closed in the hysteresis range.

In other words, when the grille 100 (e.g., portion of the grille 100) is in the state of being open prior to entering the hysteresis range, the controller 500 keeps the grille 100 open until the vehicle speed increases and exceeds the second set value. When the grille 100 (e.g., portion of the grille 100) is in the state of being closed prior to entering the hysteresis range, the controller 500 keeps the grille 100 closed until the vehicle speed decreases and falls below the first set value.

The hysteresis range is a section where the effect of fuel efficiency improvement due to energy harvesting is substantially the same as the increase in fuel consumption due to the increased air resistance of the travel wind. Frequent switching of the open or closed state of the grille 100 is not allowed, minimizing energy loss and enabling stable control.

When the vehicle speed gradually increases and exceeds the second set value in the state of the grille 100 (e.g., portion of the grille 100) being open prior to entering the hysteresis range, the controller 500 closes the grille 100 through the shutter unit 200 to reduce aerodynamic resistance, maximizing the effect of aerodynamic improvement during high-speed travelling and improving fuel efficiency.

Conversely, when the vehicle speed gradually decreases and falls below the first set value in the state of the grille 100 (e.g., portion of the grille 100) being closed prior to entering the hysteresis range, the controller 500 controls the shutter unit 200 to open the grille 100. The controller 500 opens the grille 100 (e.g., portion of the grille 100) to operate the power generator unit 300 to start harvesting wind energy.

The controller 500 operates the shutter unit 200 based on the change in the vehicle speed to flexibly control the opening and closing state of the grille 100 (e.g., portion of the grille 100), optimizing the travelling performance and energy efficiency of the vehicle. This enables efficient travelling of the vehicle by achieving a balance between reducing vehicle's aerodynamic resistance and harvesting wind energy.

To sum up, the controller 500 in the present disclosure controls the shutter unit 200 to open or close the grille 100 (e.g., portion of the grille 100) based on the vehicle speed. When the grille 100 (e.g., portion of the grille 100) is opened, the power generator unit 300 operates to produce electricity through energy harvesting, providing improved fuel efficiency. Moreover, when the vehicle speed is at or above a predetermined level, the grille 100 (e.g., portion of the grille 100) is closed, improving aerodynamics and fuel efficiency. Furthermore, the present disclosure provides a technical feature of preventing frequent opening or closing of the grille 100 (e.g., portion of the grille 100) by setting the range of vehicle speed greater than or equal to the first set value and smaller than the second set value as a hysteresis range.

As should be apparent from the above description, the present disclosure may have the following effects by the above-described elements, and combination and use relations thereof.

First, by generating energy using natural wind power (e.g., movement of air relative to the vehicle) during the travelling of the vehicle, energy may be generated or secured without additional fuel consumption, improving the fuel efficiency of the vehicle.

Second, the shutter unit opens or closes the grille or a portion of the grille based on the travel speed of the vehicle, increasing power generation efficiency at low speeds and reducing aerodynamic resistance at high speeds to improve aerodynamic performance.

Third, the controller automatically controls the opening and closing of the shutter unit based on the vehicle speed received from the sensor, maintaining optimal energy efficiency and aerodynamic performance without driver's intervention, and increasing travel convenience through system automation.

With these effects, according to the present disclosure, the energy efficiency of vehicles may be improved, and aerodynamic resistance may be reduced, improving a vehicle's fuel efficiency and travel performance at the same time.

The detailed description is merely illustrative of the present disclosure. In addition, the above description shows and describes various embodiments of the present disclosure, but the present disclosure can be used in various other combinations, modifications, and environments. In other words, changes or modifications are possible within the scope of the idea of the disclosure disclosed herein, the scope of equivalents to the described disclosure, and/or the scope of ordinary skill or knowledge in the art. The embodiments describe one state for implementing the technical idea of the present disclosure, and various changes required for specific application fields and uses of the present disclosure are possible. Therefore, the detailed description of the present disclosure is not intended to limit the present disclosure to the disclosed embodiments. The appended claims should be construed to include other embodiments.

What is claimed is:

1. A vehicle energy harvesting system, the system comprising:
a grille positioned at a front surface of a vehicle body frame;
at least one shutter unit positioned inside the grille and configured to open and close a portion of the grille;
a power generator unit positioned adjacent to the shutter unit and fixed to the vehicle body frame; and
a controller configured to control the shutter unit based on a vehicle speed.

2. The system of claim 1, wherein, in a hysteresis range where an absolute value of a difference between an increase in fuel efficiency due to power generated by energy harvesting and a decrease in fuel efficiency due to an increase in air resistance on the vehicle as the vehicle travels is equal to or less than a set value, the controller is configured to control the shutter unit to keep the portion of the grille open if the portion of the grille is currently open or keep the portion of the grille closed if the portion of the grille is currently closed.

3. The system of claim 2, further comprising a bumper positioned at a front surface of the vehicle and along the grille,
wherein the shutter unit comprises:
a shutter housing positioned adjacent to the grille and comprising a guide groove;
a door configured to open and close the portion of the grille inserted into the guide groove;
a link portion fastened to an inner surface of the door;
an actuator fastened to the link portion; and
a fixation panel positioned between the actuator and the bumper.

4. The system of claim 3, wherein the link portion comprises:
a first link having a first end fastened to the actuator;
a second link having a first end fastened to a second end of the first link; and
a third link to which a second end of the second link is fastened,
wherein the third link moves in a vertical direction based on the door moving in the vertical direction.

5. The system of claim 2, wherein the power generator unit comprises:
a stator core;
a core housing surrounding the stator core;
a rotor inserted into inside the stator core;
a first case facing a first end of the core housing, the rotor penetrating through the first case;
a blade having a second end inserted into the first case;
a second case surrounding a first end of the blade and brought into contact with a first end of the first case; and
a cover fastened to a first end of the second case,
wherein the power generator unit is fixed to the vehicle body frame by a bracket unit.

6. The system of claim 5, wherein the first case and the second case each have an open portion, and
wherein the power generator unit further comprises a front case fastened to the first case and the second case, wherein the front case has a first side facing the first case and the second case and has a second side facing the blade.

7. The system of claim 5, wherein the bracket unit comprises:
an extended plate fastened to the core housing;
a connection bracket positioned below the power generator unit and fastened to the vehicle body frame; and
a sub-bracket positioned below the cover and fastened to the vehicle body frame.

8. The system of claim 7, wherein the extended plate has a first end fixed to the vehicle body frame and has a second end fastened to the connection bracket, and the cover is fastened to the sub-bracket.

9. The system of claim 2, wherein the hysteresis range is a range of a value greater than or equal to a first set value and smaller than a second set value.

10. The system of claim 2, wherein, based on the vehicle speed increasing to exceed a second set value, the controller controls the shutter unit to close the portion of the grille.

11. The system of claim 2, wherein, based on the vehicle speed decreasing to fall below a first set value, the controller controls the shutter unit to open the portion of the grille.

12. A vehicle energy harvesting system, the system comprising:
a grille disposed at a front of a vehicle body;
a shutter unit disposed inside the grille configured to open and close a portion of the grille;
a power generator unit positioned adjacent to the shutter unit; and
a controller configured to control the shutter unit to open or closed the portion of the grille based on a vehicle speed.

13. The system of claim 12, further comprising:
a bumper positioned at a front of the vehicle along the grille, wherein the shutter unit is coupled to a bottom portion of the bumper.

14. The system of claim 12, wherein the shutter unit includes:
a shutter housing adjacent to the grille including a guide groove; and
a door disposed in the guide groove and configured to open or close the portion of the grille by traveling along the guide groove.

15. The system of claim 14, further comprising:
a link portion fastened to an inner surface of the door; and
an actuator coupled to the link portion, the actuator configured to move the door so as to open or close the portion of the grille.

16. The system of claim 14, further comprising:
an actuator;
a first link having a first end coupled to the actuator;
a second link having a first end coupled to a second end of the first link; and
a third link to which a second end of the second link is coupled,
wherein the actuator is configured to move the door so as to open or close the portion of the grille.

17. The system of claim 12, wherein the power generation unit comprises:
a blade;
a stator core;
a core housing surrounding the stator core; and
a rotor disposed inside the stator core.

18. The system of claim 12, wherein the controller controls the shutter unit to open the portion of the grille based on the vehicle speed decreasing below a first set value.

19. The system of claim 18, wherein the controller controls the shutter unit to close the portion of the grille based on the vehicle speed increasing to exceed a second set value.

20. A vehicle energy harvesting system, the system comprising:
a grille disposed at a front of a vehicle body;
a shutter unit including a shutter housing including a guide groove and a door disposed along the guide groove, the shutter unit disposed inside the grille and configured to open and close a portion of the grille;
a power generator unit including a blade, a stator core, and a rotor disposed adjacent to the shutter unit; and
a controller configured to control the shutter unit to move the door, opening or closing the portion of the grille based on a vehicle speed.
